(19) United States
(12) Patent Application Publication
(10) Pub. No.: US 2014/0190843 A1
(43) Pub. Date: Jul. 10, 2014

(54) Locking Mechanism of a Protective Case for a Portable Electronic Device

(71) Applicant: Mattel, Inc., El Segundo, CA (US)

(72) Inventors: Ross RUMFOLA, III, Akron, NY (US); Daniel J. DAMON, South Wales, NY (US); Jared P. PARDI, Cheektowaga, NY (US); Donald W. STUCKE, Jr., East Aurora, NY (US)

(73) Assignee: Mattel, Inc., El Segundo, CA (US)

(21) Appl. No.: 14/147,070

(22) Filed: Jan. 3, 2014

Related U.S. Application Data
(60) Provisional application No. 61/748,987, filed on Jan. 4, 2013.

(51) Int. Cl. E05C 1/08; A45C 11/00

(52) U.S. Cl. CPC E05C 1/08; A45C 11/00
USPC 206/37; 29/428; 292/157

(57) ABSTRACT

A protective case for a portable electronic device includes a top and a bottom that define an interior configured to receive a portable electronic device. The top and bottom are hingedly coupled to one another along at least one side and removably coupled together by a latch along another side, opposite the hinged side. The latch includes two actuators and in order to open the protective case, both actuators must be actuated simultaneously.

### CROSS-REFERENCE TO RELATED APPLICATION

This application claims priority to and is based on U.S. patent application No. 61/748,987, filed Jan. 4, 2013, Attorney Docket No. 0621.2148P, entitled “Locking Mechanism of a Protective Case for a Portable Electronic Device,” the entire disclosure of which is incorporated herein by reference in its entirety.

### FIELD OF THE INVENTION

The present invention relates to a protective case for a portable electronic device, and in particular, a locking mechanism that may retain the case in closed or locked configuration.

### BACKGROUND OF THE INVENTION

Various protective covers, cases, and sleeves for portable electronic devices (“PEDs”), such as cellular phones, smart devices, media players, and portable computers, are known. Some designs protect a PED from damage and scratches, but do not permit use of the PED when the PED is disposed in the protective case. Other designs permit use of the PED when the PED is disposed in the cover, but do not sufficiently protect the device from damage, misuse, or unauthorized use when handled by young children or infants. Furthermore, some designs allow a PED to be slipped into a protective case, while others lock a PED within a protective case. Locking protective cases, however, are often difficult to open, thereby making it difficult for a user to insert and remove a PED from the case.

Therefore, there is a need for a protective case for a PED that is appropriate for use by infants and young children. In addition, there is a need for a protective case for a PED that has a child-safe lock or locking mechanism that can be easily opened and easily locked closed by a parent.

### SUMMARY OF THE INVENTION

According to one exemplary embodiment, a protective case for a portable electronic device includes a top, a bottom, and a latch. The top and bottom are rotatably coupled together along a first transverse edge and removably coupled together along a second, opposite transverse edge and the latch is configured to removably couple the top to the bottom along the second transverse edge. The latch includes at least two projections and at least two actuators, each configured to actuate at least one of the projections, wherein actuation of all of the projections allows the latch to be decoupled.

### BRIEF DESCRIPTION OF THE DRAWINGS

FIG. 1 shows a front view of an exemplary embodiment of a protective case for a PED with a locking mechanism according to the present invention.

FIG. 2 shows a top perspective view of a top edge of the exemplary embodiment shown in FIG. 1, including at least a portion of the locking mechanism.

FIG. 3 shows a perspective view of the locking mechanism of FIG. 2.

FIG. 4 shows a perspective view of the locking mechanism of FIG. 2 in an actuated position.

FIG. 5 shows a perspective view of the protective case in a partially open configuration, illustrating how the protective case may be opened.

FIG. 6 shows an interior perspective view of a portion of the protective case of FIG. 1, including portions of the locking mechanism.

FIGS. 7-8 show interior perspective views of another portion of the protective case of FIG. 1 and illustrate how portions of the locking mechanism may be actuated.

FIGS. 9 and 10 show interior views of the protective case of FIG. 1, illustrating how the protective case may receive a PED therein.

Like reference numerals have been used to identify like elements throughout this disclosure.

### DETAILED DESCRIPTION OF THE INVENTION

This application incorporates herein by reference, in their entirety, the disclosures of U.S. Non-Provisional application Ser. No. 13/351,811, entitled “Protective Case for Portable Electronic Device,” filed Jan. 17, 2012, and U.S. Provisional Application No. 61/596,759 entitled “Protective Case for Portable Electronic Device,” filed Feb. 9, 2012.

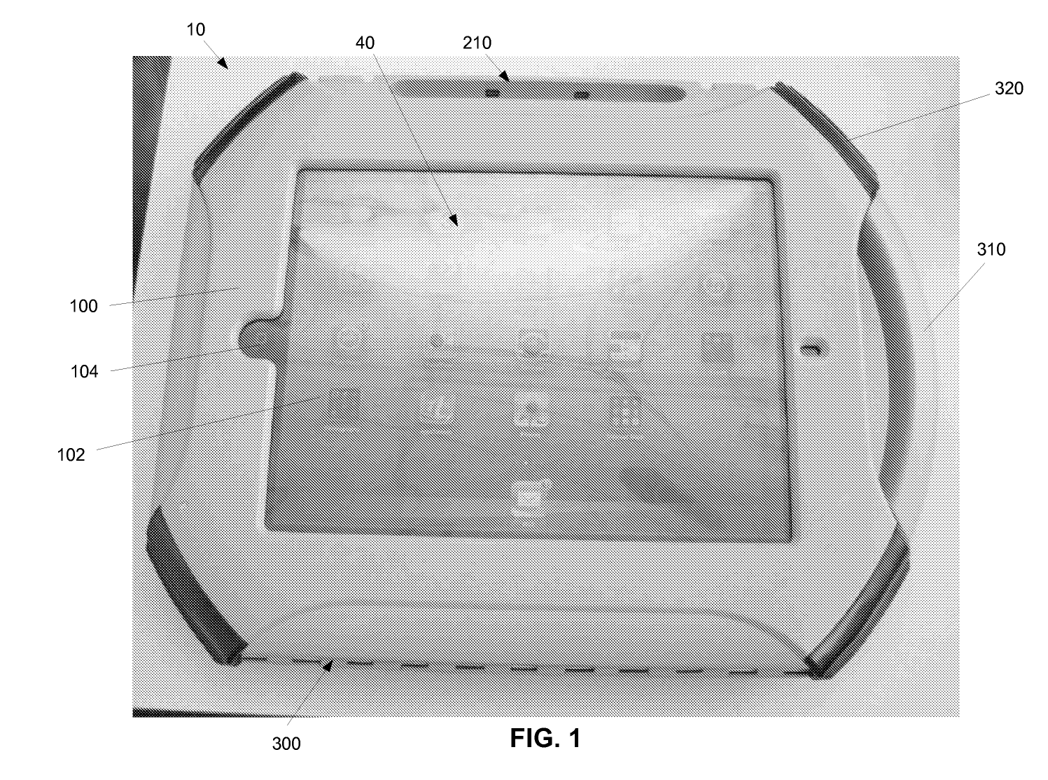

Referring generally to FIGS. 1-10, an exemplary embodiment of a protective case configured to receive a PED is shown. The protective case includes a top and a bottom which may be secured together, around a PED, with a locking mechanism or latch. The latch requires actuation in multiple locations, as well as directions, to unlock the case. Once unlocked, the top of the case may be separated from the bottom of the case in order to insert or remove a PED therefrom. The protective case also includes a tray or receptacle configured to securely receive a PED within the case.

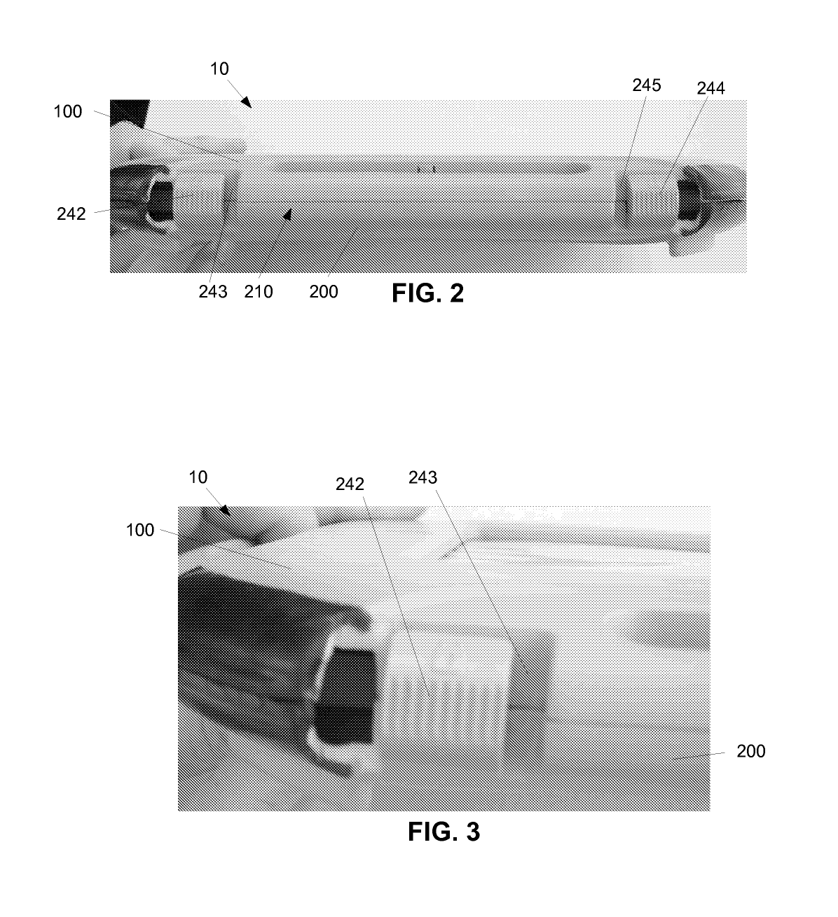

Referring to FIG. 1, a protective case 10 is shown from a front perspective with a PED 40 housed therein. The protective case 10 is formed from two members or panels, top 100 and bottom 200 (see FIG. 2), which are hingedly or rotatably coupled together along one edge and removably coupled together along a second and opposite end such that they form a housing or cavity configured to receive a PED 40. In the exemplary embodiment shown in FIG. 1, the top 100 and bottom 200 are hingedly coupled together along their lower transverse edges via a hinge 300 and are removably coupled together along their upper transverse edges via latch 210, wherein upper and lower refer to the upper and lower edges as seen in FIG. 1. In the illustrated embodiment, hinge 300 is a continuous hinge. In other embodiments, the hinge 300 may be another type of hinge, including a living hinge. Furthermore, in other embodiments, top 100 and bottom 200 may be rotatably coupled together on any suitable edge and removably coupled along any other suitable edge, provided that the protective case may function in accordance with the scope of the invention.

Still referring to FIG. 1, protective case 10 may also include additional features to increase portability, durability, and ease of use. For example, in the exemplary embodiment shown in FIG. 1, protective case 10 may include a handle 310, bumpers 320, protective film 102, and a recessed portion 104. The recessed portion 104 may facilitate interaction with a PED 40 housed with the protective case 10 by allowing the user to have easy access to a “home” button included on a PED 40. Film 102 may provide additional protection for a PED 40 while also facilitating interaction with the PED 40 by providing a covering for the display of a PED 40 that allows touch-based inputs and interaction. For example, film 102 may be formed from a thin, conductive plastic which covers the display screen of a PED 40 and prevents scratching, but still allows a PED 40 housed under film 102 to sense “touches” by a user and function as intended.

The handle 310 and bumpers 320 may be formed separately or integrally with the protective case 10 and may be disposed on any edge of the protective case. However, in preferred embodiments, the handle 310 and bumpers 320 are disposed on a different edge than both hinge 300 and latch 210 so that handle 310 and bumpers 320 do not interfere with the functionality of these features. The handle 310 may be included in protective case 10 to provide the user with an easy way to carry the protective case and the bumpers 320 may be included to provide additional protection in areas likely to receive large impacts during use by a child.

Now turning to FIG. 2, the exemplary protective case 10 is shown from a front perspective view of a top edge, such that the latch included on the upper transverse edges of top 100 and bottom 200 is shown. As can be seen, the latch 210 includes two actuators, first actuator 242 and second actuator 244, which allow top 100 and bottom 200 to be removably coupled together along one of their edges. In this embodiment, actuators 242, 244 are the only portion of latch 210 disposed on the exterior of protective case 10. Although other embodiments may include other portions or parts of latch 210 on the exterior of case 10, preferred embodiments only expose actuators 242 and 244 so that a child cannot access the majority of the mechanical parts of latch 210. Additionally, by only exposing actuators 242 and 244, protective case 10 will have a streamlined design and will be less likely to snag on clothing or other objects when a child is playing with a PED 40 stored within case 10.

In FIG. 3, one of the actuators, first actuator 242 is shown in more detail. As can be seen, the actuator 242 may include various indicia or patterns to make the actuator easier to grip or locate. Additionally, FIG. 3 illustrates how actuator 242 sits within a recess 243 formed in the top transverse edges of the top 100 and bottom 200. Thus, the actuator 242 does not extend beyond the periphery of the protective case 10, again eliminating dangers associated with snagging, thereby protecting both the child and the latch 210. Additionally, as can be seen in FIG. 2, actuator 244 may also sit within a similar recess, recess 245. Recesses 243 and 245 may also include a slot or slit (not pictured) along a bottom wall or a side wall, so that the actuators 242, 244 may be mechanically coupled, in any suitable manner, to the interior portions of latch 210, even as the actuators slide within their respective recesses. For example, actuators 242 and 244 may be coupled to the interior elements of latch 210 via extensible coupling members (not shown) which extend through the outer walls of recesses 243, 245, respectively.

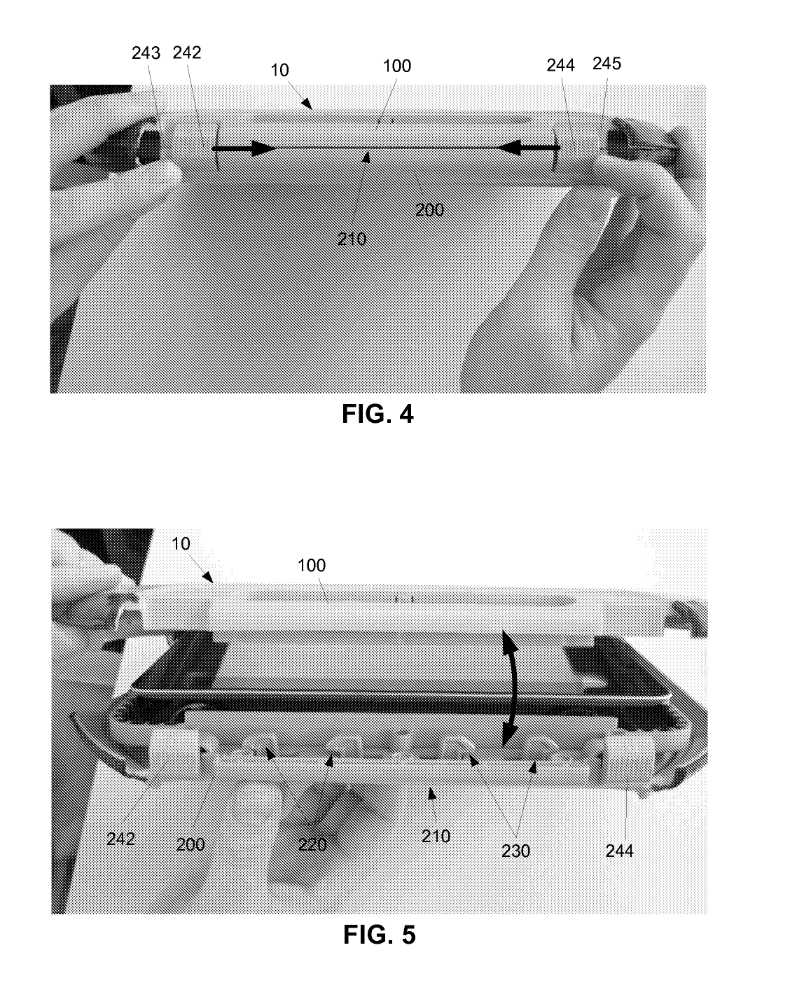

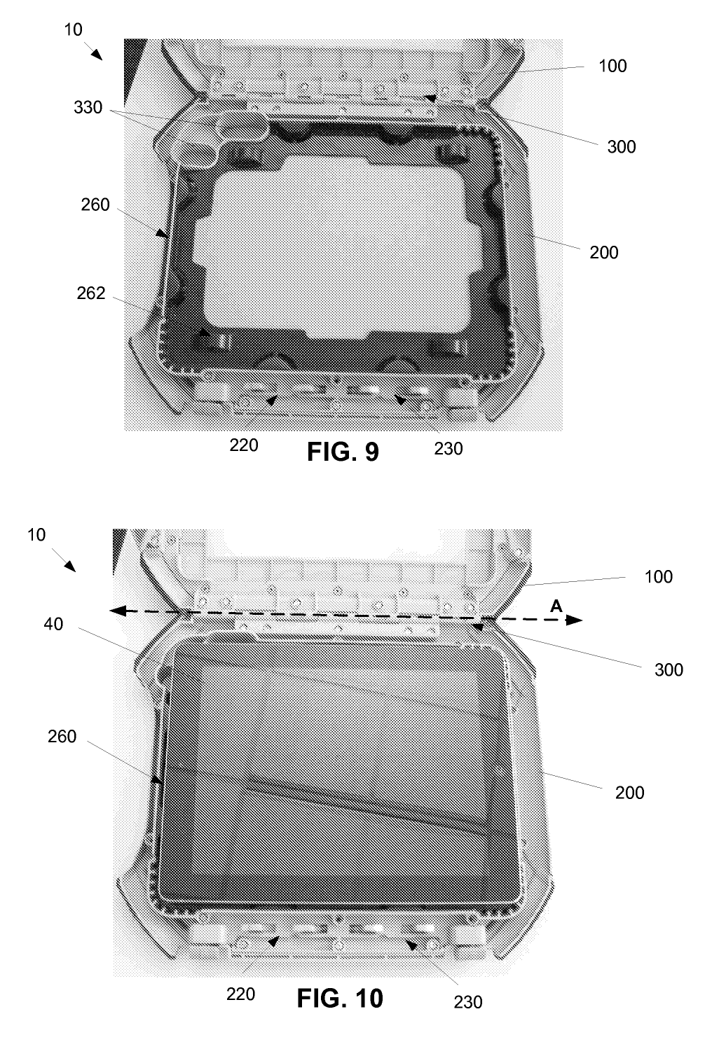

Now referring to FIGS. 4-5, an exemplary manner of actuating actuators 242 and 244 is illustrated. In FIG. 4, each of the actuators 242, 244 is pushed inwardly, towards each other and the interior wall of their respective recess 243, 245. As will be explained in further detail below, when the actuators 242, 244 are moved to this position, the latch 210 will be disengaged and the top 100 may be lifted away from the bottom 200, as shown in FIG. 5. Once the latch is disengaged, the top 100 and bottom 200 may be free to rotate about the axis that the hinge 300 provides, such as axis A shown in FIG. 10, to any desirable position. However, in some embodiments, the range of motion of the top 100 and bottom 200 may be limited by each other, a detent included in hinge 300, or in any other suitable manner. For example, in the exemplary embodiment of FIGS. 4-5, the top 100 and bottom 200 may be shaped so that they may not rotate further than 180 degrees with respect to each other. In other words, the top 100 and bottom 200 may be laid flat, as seen in FIGS. 9-10, but may not rotate past a flat position.

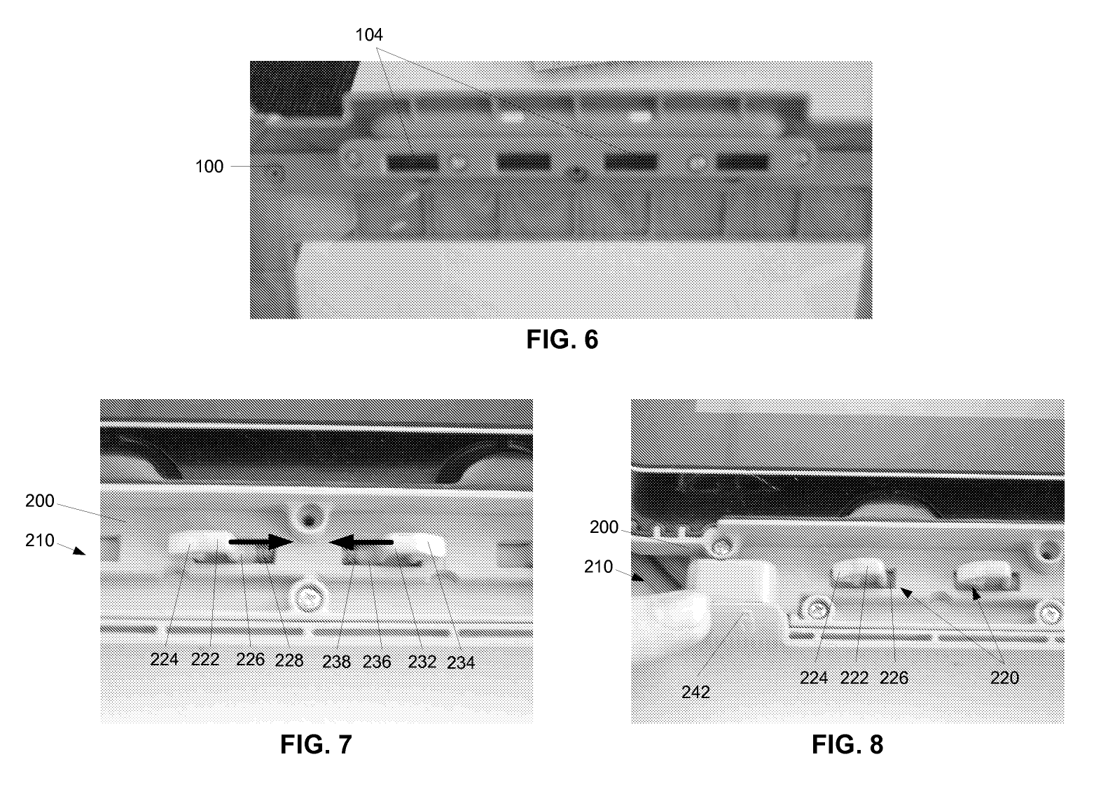

Still referring to FIG. 5, but now with reference to FIGS. 6-8 as well, latch 210 includes interior components configured to lock top 100 to bottom 200. The bottom 200 includes two sets of protrusions, first set 220 and second set 230 which are each configured to engage corresponding openings 104 included on top 100 (see FIG. 6). In the exemplary embodiment shown in FIGS. 5 and 6-8, each set 220, 230 includes two projections, first set 220 including two projections 222 and second set 230 including two projections 232. However, in other embodiments, each set 220, 230 may include any suitable number of projections 222, 232. Regardless of the number of projections, each of the projections included in a set 220 or 230 may be mechanically coupled to the other projections included in that set, such that all projections 242, 244 in a set of projections 220, 230 may be actuated together when an actuator is actuated. In the exemplary embodiment shown in FIGS. 5-8, actuator 242 may actuate any projections 222 included in set 220 and actuator 244 may actuate any projections 232 included in set 230.

Now turning to FIGS. 6-8, each projection 222, 232 extends from or through a slot 226, 236 included in the interior surface of bottom 200 and is slidable or movable therein. Although FIGS. 7-8 only show select projections, it is to be understood that each projection included in a set 220, 230 may be identical to other projections in that set and may only differ from the projections included in the other set in orientation. More specifically, projections 222 and 232 may be substantially similar in that they may both be substantially “L-shaped” and, as will be discussed in further detail below, may both be biased against the external edge of their respective slot, wherein “external” denotes the edge disposed closest to a lateral edge of bottom 200. However, the projections 222 and 232 may be oriented differently because the tops of the L-shaped projections 222, 232 (denoted by reference numerals 224 and 234 and referred to herein as overhanging portion 224 or 234) may “point” in different directions. Thus, projections 222 and 232 are essentially mirrored versions of each other and, as such, any description of a projection 222, 232 included herein may be representative of all of the projections included in latch 210.

Still referring to FIGS. 6-8, each slot 226, 236 may mirror and substantially align with an opening 104 included on the top 100, such that when top 100 is closed atop of bottom 200, each slot 226, 236 may form one contiguous cavity with each opening 104. Thus, if the entirety of a projection 222, 232 is disposed within its slot 226, 236, it may be received in an opening 104 when the top 100 and bottom 200 are closed together. However, in some embodiments, such as the one shown in FIGS. 6-8, the projections 222, 232 may be biased in an orientation where the overhanging portion 224, 234 is extending past an exterior lateral edge of its respective slot 226, 236. For example, as can be seen in FIG. 7, projections 222, and 232 may be biased against the exterior edges of slots 226 and 236 by a biasing member 228 or 238, respectively, such that the overhanging portions 224 and 234 extend past the respective exterior lateral edges of slots 226 and 236 when in a biased position.

Thus, in order to insert, and subsequently lock the projections 222, 232 within openings 104 the projections 222, 232 must first be moved within slots 226, 236 (see FIG. 8). However, in some embodiments, such as the embodiment of FIGS. 6-8, overhanging portions 224 and 234 may include angled or sloped top surfaces that may allow the projections 222, 232 to essentially be pushed or forced into the opening 104 as the top 100 and bottom 200 are closed together. Thus, even if the projections 222, 232 are disposed slightly exteriorly of their respective slots 224, 234, the projections 222, 232 may still, in some embodiments, be inserted into openings 104. In other words, the projections 222, 232 may automatically align with opening 104 when the top 100 and bottom 200 are closed together. Alternatively, each set of projections 220, 230 may be moved within slots 226, 236 by simultaneously actuating actuators 242, 244.

In the present embodiment, and as seen in the illustrated embodiment of FIGS. 7 and 8, simultaneously actuating actuators 242, 244 may move all of the projections 222, 232 centrally, so that each of the projections may be disposed within its respective slot 226, 236. More specifically, actuator 242 may actuate set 220 while actuator 244 may actuate set 230. In other embodiments, any suitable system of actuation that requires both actuators 242 and 244 to be actuated in order to align the projections 222, 232 with their respective slots 226, 236 may be used. Once projections 222 and 232 are disposed within slots 226 and 236, projections 222, 232 may be inserted into (or removed from) openings 104.

Thus, if projections 222, 232 are being manually aligned with openings 104 in order to close the protective case 10, actuators 242, 244 should be kept in an actuated position until after projections 222, 224 are inserted into openings 104. Once projections 222, 224 are inserted into openings 104, actuators 242, 244 may be released, allowing the projections 222, 224 to return to their biased or non-actuated positions (see FIG. 7). In their biased positions, the overhanging portions 224, 234 may extend over the lateral edges of openings 104, thereby locking top 100 to bottom 200. In order to secure the projections 222, 232 within openings 104, the underside of the overhanging portions 224, 234 is preferably flat.

In order to remove or unlock top 100 from bottom 200, the steps required for manually aligning the projections 222, 232 with openings 104 may be taken in reverse. More specifically, both actuators 242, 244 may be depressed, thereby aligning projections 222, 232 with the openings 104 and allowing the projections 222, 232 to be removed from the openings 104. The case will only be openable once both of the redundant actuators 242, 244 are utilized by a parent. Once the projections 222, 232 are aligned with openings 104, top 100 and bottom 200 may be moved away from each other thereby opening the protective case 10. The actuators 242, 244 may be released any time after the projections 222, 232 have been removed from openings 104. In contrast with the steps for closing the case 10, the case 10 may not be opened by simply pulling the top 100 and bottom 200 apart—in part because the underside of the overhanging portions 224, 234 is preferably flat—and, thus, provides a case 10 that will substantially prevent a child from removing a PED 40 from the case 10. Additionally, a child would have difficulty simultaneously actuating both actuators 242, 244.

Now referring to FIGS. 9-10, the bottom 200 may include a tray 260, which positions a PED 40 in the proper position within the protective case 10. The tray 260 may include a plurality of resilient members 262 that serve to cushion and maintain the position of the PED 40 within the tray 260 (illustrated in FIG. 10). Due to their locations, the resilient members 262 may limit movement with respect to both the horizontal and vertical axis. For example, the resilient members 262 of the tray 260 may position the display screen of a PED 40 adjacent to film 102, so that the film 102 and resilient members 262 prevent vertical movement of the PED 40.

Additionally, FIGS. 9-10 provide a perspective view of the protective case 10 disposed in a flat configuration. As can be seen in FIGS. 9-10, and as mentioned above with respect to FIG. 4-5, the top 100 and bottom 200 may rotate about axis A in order to reach this configuration such that a PED 40 may be easily inserted into tray 260. In order to remove a PED 40, the bottom 200 may also include openings 330 which may allow a user to push the PED 40 out of tray 260 from the bottom so the user can easily grab and remove the PED 40 when desired. Thus, openings 330 may allow a user to remove a PED 40 without turning the entire case 10 upside down, minimizing the risk of damage to the PED 40.

It is to be understood that a protective case for a portable electronic device and a locking mechanism included therein may be fabricated from any suitable material, or combination of materials, such as plastic, foamed plastic, wood, cardboard, pressed paper, metal, supple natural or synthetic materials including, but not limited to, cotton, elastomers, polyester, plastic, rubber, derivatives thereof, and combinations thereof. Suitable plastics may include high-density polyethylene (HDPE), low-density polyethylene (LDPE), polystyrene, acrylonitrile butadiene styrene (ABS), polycarbonate, polyethylene terephthalate (PET), polypropylene, ethylene-vinyl acetate (EVA), or the like. Suitable foamed plastics may include expanded or extruded polystyrene, expanded or extruded polypropylene, EVA foam, derivatives thereof, and combinations thereof.

It is also to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points or portions of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the invention.

Although the disclosed inventions are illustrated and described herein as embodied in one or more specific examples, it is nevertheless not intended to be limited to the details shown, since various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

What is claimed is:

1. A locking mechanism of a protective case for a portable electronic device comprising:
a first set of protrusions extending outwardly from a first side of the protective case, the first set of protrusions being movably coupled to the first side;
a second set of protrusions extending outwardly from the first side of the protective case, the second set of protrusions being movably coupled to the first side;
a first actuator configured to move the first set of protrusions upon actuation;
a second actuator configured to move the second set of protrusions upon actuation; and
a plurality of openings including on a second side of the protective case, the plurality of openings configured to receive or release the first and second sets of protrusions upon simultaneous actuation of the first and second actuators, wherein the protective case is configured to receive the portable electronic device between the first and second sides of the protective case.

2. The locking mechanism of claim 1, wherein the first and second sets of protrusions each include at least two protrusions.

3. The locking mechanism of claim 1, wherein the first set of protrusions moves in a first direction upon actuation of the first actuator and the second set of protrusions moves in a second direction upon actuation of the second actuator, the second direction being opposite the first direction.

4. The locking mechanism of claim 3, wherein the first and second sets of protrusions are biased to rest positions when the first and second actuators are not actuated.

5. The locking mechanism of claim 1, wherein each protrusion included in the first and second sets of protrusions has a substantially inverted L-shape, such that each protrusion includes a top extending away from the protrusion.

6. The locking mechanism of claim 5, wherein the tops of the first set of protrusions point in a first direction and the tops of the second set of protrusions point in a second direction, the second direction being opposite the first direction.

7. The locking mechanism of claim 5, wherein the each opening included in the plurality of openings includes a perimeter and the tops of the first and second sets of protrusions extend beyond the perimeter of the corresponding opening prior to actuation.

8. The locking mechanism of claim 7, wherein the top of each of the protrusions included in the first and second set of protrusions includes a sloped upper surface such that the first and second sets of protrusions may be urged into their corresponding openings when the first side and second side of the protective are closed together, such that the first and second sides of the protective case may be secured together without a user directly actuating the first and second actuators.

9. The locking mechanism of claim 1, wherein the locking mechanism prevents the first and second side of the protective case from opening without simultaneous actuation of the first and second actuators.

10. A protective case for a portable electronic device, comprising:
a top;
a bottom, the top and bottom being rotatably coupled together along a first transverse edge and removably coupled together along a second, opposite transverse edge; and
a latch configured to removably couple the top to the bottom along the second transverse edge, the latch including at least two projections and at least two actuators, each of the at least two actuators being configured to actuate at least one of the projections, wherein actuation of all of the projections allows the top to be decoupled from the bottom along the second transverse edge, wherein the protective case is configured to receive the portable electronic device between the top and bottom of the protective case.

11. The protective case of claim 10, wherein the at least two projections comprise:
a first set of projections; and
a second set of projections, wherein the first set of projections moves in a first direction upon actuation of a first actuator of the at least two actuators and the second set of projections moves in a second direction upon actuation of a second actuator of the at least two actuators, the second direction being opposite the first direction.

12. The protective case of claim 11, wherein the first and second sets of projections are biased to rest positions when the first and second actuators are not actuated.

13. The protective case of claim 11, wherein each projections included in the first and second sets of projections has a substantially inverted L-shape, such that each projection includes an overhanging portion extending away from the projection.

14. The protective case of claim 13, wherein the overhanging portions of the first set of projections point in a first direction and the overhanging portions of the second set of projections point in a second direction, the second direction being opposite the first direction.

15. The protective case of claim 10, further comprising:
at least two openings, each opening being configured to receive one of the at least two projections.

16. The protective case of claim 15, wherein a top surface of each of the projections included in the at least two projections is sloped, such that closing the second transverse edges of the top and bottom together may serve to actuate the projections without direct actuation of the at least two actuators by a user.

17. The protective case of claim 10, wherein the latch prevents the top and bottom of the protective case from rotating away from each other along their second transverse edges unless each of the at least two actuators is simultaneous actuated.

18. A method of securing a portable electronic device within a protective case that is child-safe, comprising the steps of:
inserting a portable electronic device into a housing of a protective case, the housing being formed by a top portion and a bottom portion;
closing the top portion and bottom portion around the portable electronic device;
securing the top portion to the bottom portion with a latch, wherein the latch may only be disengaged by simultaneous actuation of at least two actuators, wherein each of the actuators actuates a different set of protrusions included in the latch and every set of protrusions included in the latch must be actuated in order to release the latch.

19. The method of claim 18, wherein the different sets of protrusions are biased to non-actuated positions, such that all of the at least two actuators must be simultaneously actuated in order to release the latch.

20. The method of claim 18, wherein closing the top portion and bottom portion around the portable electronic device automatically locks the latch included on the protective case, such that actuation of the at least two actuators is only required to unlock the latch.
